(19) United States
(12) Patent Application Publication
(10) Pub. No.: US 2012/0143954 A1
(43) Pub. Date: Jun. 7, 2012

(54) METHOD FOR ADAPTING DATA IN A DATA TRANSMISSION SYSTEM, AND ASSOCIATED SYSTEM

(75) Inventors: Hugues Vincent, Antony (FR); Ngoc ChâuTrân Huynh, Paris (FR)

(73) Assignee: THALES, NEUILLY SUR SEINE (FR)

(21) Appl. No.: 13/322,220

(22) PCT Filed: May 21, 2010
(86) PCT No.: PCT/EP2010/057069

§ 371 Date: Jan. 17, 2012

(30) Foreign Application Priority Data
May 26, 2009 (FR) 0902523

(51) Int. Cl. G06F 15/16

(52) U.S. Cl. 709/204

(57) ABSTRACT

A system for adapting data including at least one sender executing at least one calling application and one receiver executing at least one called application, the senders and receivers being interconnected via a communication network, said calling application generating messages addressed to said called application, said messages being structured according to a first syntax S_{A}, said called application being adapted to receive messages structured according to a second syntax S_{B}, wherein said system includes an ontological knowledge base and a directory of services common to the senders and receivers, each sender including a translation module connected to said knowledge base and to said directory adapted to structure said messages according to the second syntax S_{B}.

The present invention relates to a system and a method for adapting data in the context of a data transmission between a sender and a receiver which do not share the same syntactic definition of these data.

The invention applies notably to the context of communicating systems made up of software applications which interchange messages.

A software application connected to a multivendor communication network communicates, in most cases, with another remote application through messages containing data. These messages may have the same semantic nature, that is to say, convey the same content, but present a different syntax or schema of the structure of the data. For example, a message which defines a postal address may be generated by a first application in the form of a single data structure containing the following fields: an integer number specifying a street number, an enumerator specifying a street type, a character string specifying a street name, an integer number specifying a postal code, a character string specifying a town and a character string specifying a country. This same message defining the same postal address may be generated by a second application with a different syntax, for example a first data structure indicating the town and containing the postal code, the name of the town and the name of the country in the form of character strings and a second data structure indicating the street and containing its number, its type and its name specified in the form of character strings. In this example, the semantic contents of the two messages are identical but their syntax is different which generates interworking problems between the applications.

The problem that the present invention seeks to resolve is notably how to enable data to be exchanged between a number of applications without them in any way sharing the same data schema or the same syntax.

The known solutions to this problem are of several types. First of all, the interworking can be managed by a first conversion of the format of the source message to a pivot format and then a second conversion of the pivot format to the target message format. This solution presents the drawback of generating a long computation time. Furthermore, the writing of these two conversions is left as the responsibility of the suppliers of the client and server applications since they alone control the source and target formats respectively. This generates additional work that they have to take into account when developing their applications.

Furthermore, it is possible to lose information in the switch through an intermediate pivot format.

Other solutions are based on the use of dictionaries that make it possible to compute a conversion of the format of the source message to the format of the target message by trying to establish mappings between the elements of the messages and their data structures. The use of dictionaries is not, however, sufficient, because it cannot provide any assurance of an exact mapping between two terms in all cases, for example the abbreviated forms of a term are not taken into account by a dictionary.

In order to resolve the problem mentioned previously, the invention proposes a method for adapting data that makes it possible to dynamically convert a source non-hierarchical data format to a structured data format used by a target with which communication is desired. The expression “non-hierarchical data format” refers to a set of data of various types placed end-to-end in order to form a message with no particular structure.

The method and the system according to the invention rely on the use of a knowledge or ontology base in which a set of semantic concepts are defined.

The invention notably offers the following advantages: the use of an ontology as common knowledge base provides greater comprehensiveness than a dictionary notably by virtue of the relationships that exist between two semantic concepts such as, for example, the equivalence relationship. Furthermore, abandoning the pivot format significantly reduces the computation time.

The subject of the invention is a system for adapting data comprising at least one sender executing at least one calling application and one receiver executing at least one called application, the senders and receivers being interconnected via a communication network, said calling application generating messages addressed to said called application, said messages being structured according to a first syntax S_{A}, said called application being adapted to receive messages structured according to a second syntax S_{B}, said system being characterized in that it includes an ontological knowledge base and a directory of services common to the senders and receivers, said adaptation system also including a translation module connected to said base and to said directory adapted to perform a direct translation of said messages according to the second syntax S_{B}.

In a variant embodiment of the invention, said ontological knowledge base defines a set of semantic specifications of the data exchanged between the senders and the receivers of said system, said specifications being formalized by semantic concepts interlinked by dependency relationships, said translation module being adapted to use the content of said base in order to map the semantic specifications of the message structured according to the syntax S_{A} with those of the message structured according to the syntax S_{B} so that said messages present the same semantic content.

In a variant embodiment of the invention, the translation module is also adapted to use the relationships between semantic concepts defined in the ontological knowledge base to widen the mapping searches between the semantic specifications of the messages structured according to two different syntaxes S_{A}, S_{B}.

In a variant embodiment of the invention, the directory of services contains all the syntaxes S_{A}, S_{B} associated with the applications executed by the senders and receivers of said system.

In a variant embodiment of the invention, the syntax S_{A} of the calling application is defined as the sequencing of a set of data with no particular structure or specific order.

In a variant embodiment of the invention, the semantic specifications contained in the ontological knowledge base are defined using the resource description framework definition language or the web ontology language definition language.

In a variant embodiment of the invention, the syntaxes S_{A}, S_{B} contained in the directory of services are defined using the interface description language (IDL) or the XML schema description (XSD) language, or even by a diagram defined in unified modeling language (UML).

In a variant embodiment of the invention, said translation module is specific to each sender or is common to all the applications executed by the senders and receivers of said system and centralized in a software bus.

Also the subject of the invention is a method for adapting data in a system comprising at least one sender executing at least one calling application and one receiver executing at least one called application, the senders and receivers being interconnected via a communication network, said calling application generating at least one message addressed to said called application, said message being structured according to a first syntax S_{A}, said called application being adapted to receive at least one message structured according to a second syntax S_{B}, said method being characterized in that it comprises at least the following steps:
a step for associating said message with an identifier of the called application that is the recipient of said message;
a step for determining the syntax S_{B} associated with the called application from its identifier,
a step for direct translation of said message into a format adapted to the syntax S_{B} but having the same semantic content as the initial message, from the mapping between the semantic specifications of the syntax S_{A} and those of the syntax S_{B},
a step for transmitting said converted message to the called application via said communication network.

Other features will become apparent upon reading the following detailed description given as a nonlimiting example and in light of the appended drawings which represent:

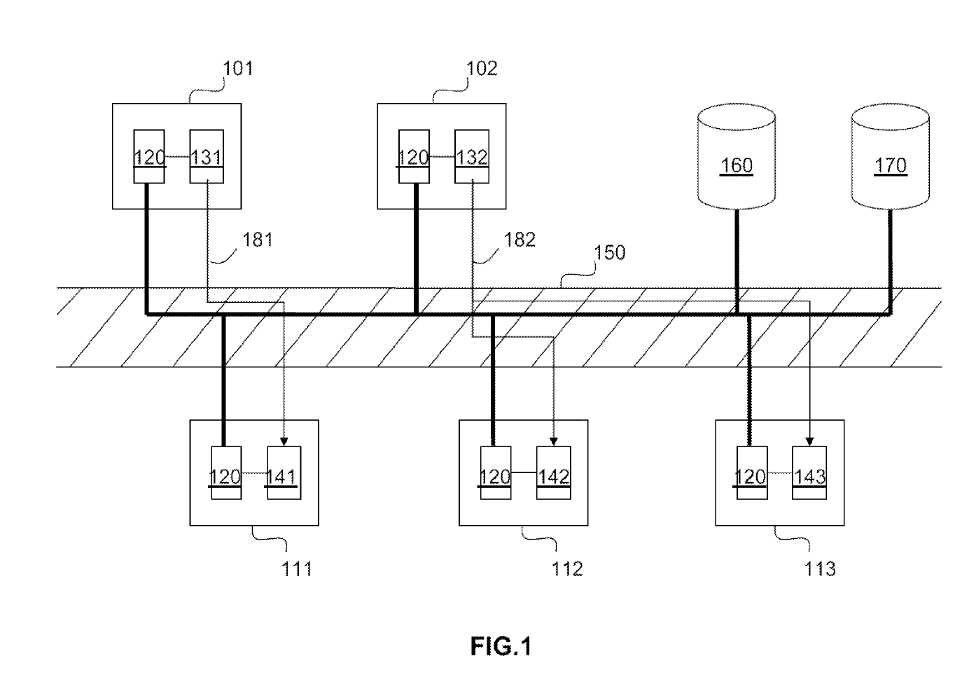

FIG. 1, a diagram illustrating one embodiment of the data adaptation system according to the invention,

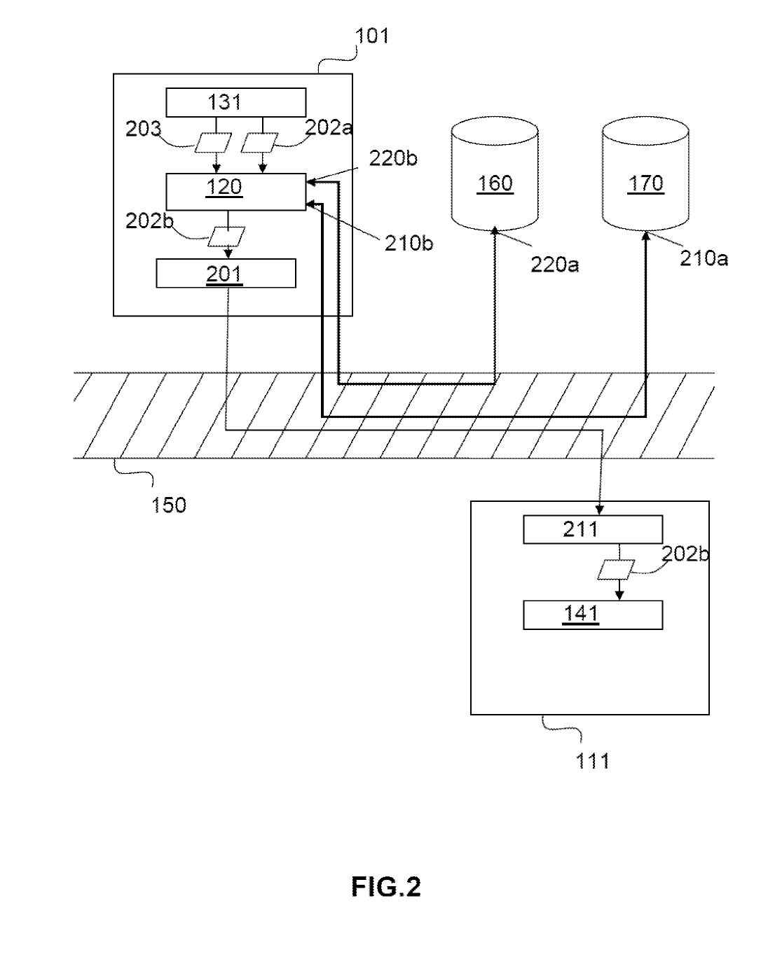

FIG. 2, a diagram illustrating the steps implemented in the transmission of a source data message to a target having its own data structure schema,

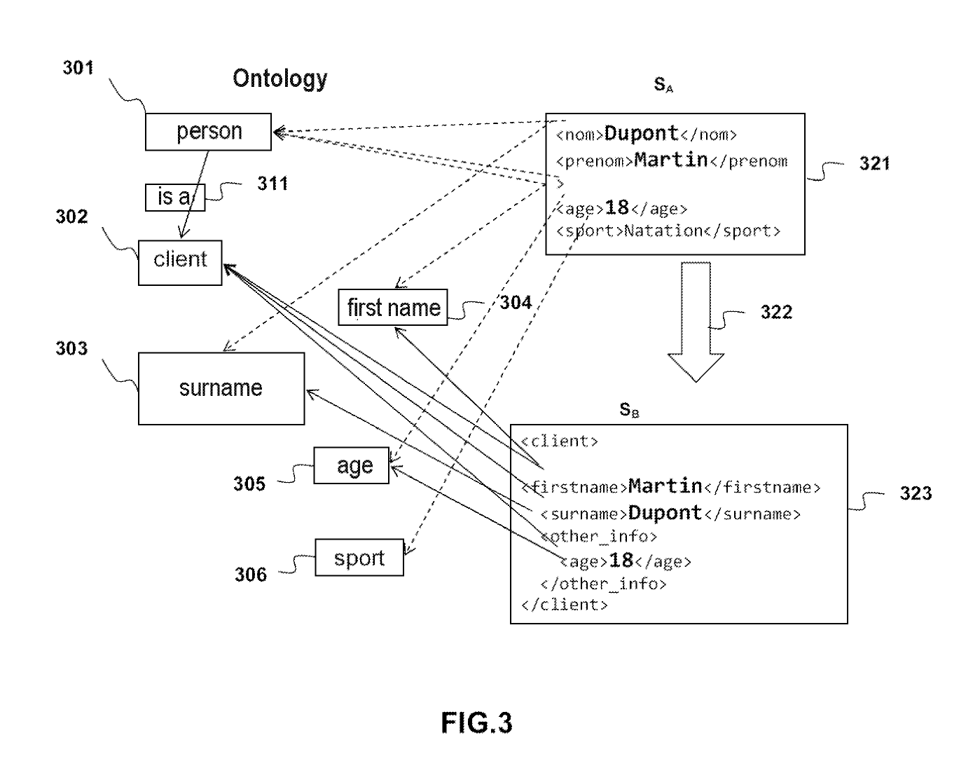

FIGS. 3, 4 and 5, exemplary embodiments of the invention.

FIG. 1 represents an exemplary embodiment of the data adaptation system according to the invention.

Data senders 101, 102 and data receivers 111, 112, 113 are connected together through a communication network 150. These senders and receivers are, for example, computer terminals which can assume both the function of sender and of receiver or just one of the two. Each sender 101, 102 executes at least one calling application 131, 132 which exchanges messages 181, 182 with a called application 141, 142, 143 executed on data receiving terminals 111, 112, 113. These messages include a set of data represented according to a particular syntax S_{A}, that is to say, a structure for presentation of their content as well as a type associated with each of the data. This syntax is specific to each calling application 131, 132. Similarly, a called application 141, 142, 143 also has a particular syntax S_{B} for the representation of the data messages that it uses. The two syntaxes, calling S_{A} and called S_{B}, may be different, which poses the problem of interoperability in the exchange of messages between two applications.

To enable each calling application 131, 132 to adapt the syntax of the messages that it wants to transmit to that of the called application 141, 142, 143, each sending terminal 101, 102 also executes a translation module 120, the function of which is to translate the message to be sent into the syntax S_{B} of the called application. This translation module 120 is, for example, a library that is local and specific to each application 131, 132 but may also be shared by a number of applications, in which case the translation module 120 is centralized in a software bus which is used, notably, to provide communication between a number of systems which are not interoperable, for example because they do not use the same communication protocols.

The translation module 120 is, furthermore, connected to an ontological knowledge base 160 and to a directory of services 170. The directory of services 170 contains all the definitions of syntaxes, also called interfaces, of messages used by all the participating applications or services 131, 132, 141, 142, 143. To this end, each new application which is registered in the system according to the invention must communicate to the directory of services 170 the syntax that it uses. The syntax may be defined using known description languages such as IDL (interface description language), XSD (XML schema description) or by a UML (unified modeling language) diagram.

The ontological knowledge base, or ontology, 160 contains all the semantic specifications necessary to explain a knowledge domain. Examples of such knowledge domains are health, security applications or electronic administration. The ontology 160 comprises, for each knowledge domain that it processes, a data model comprising a set of concepts linked together by semantic relationships. These relationships are defined, for example, using a semantic specification language such as RDF (resource description framework) or OWL (web ontology language). Each concept corresponds to a semantic specification and may also include one or more instances, that is to say, elements belonging to this concept. The term “semantic specification” defines all the information associated with a datum that makes it possible to specify its meaning within the framework of a particular domain. It concerns metadata which can be used to explain as precisely as possible the content of a datum. The ontology 160 is, for example, developed by experts working in the areas affected by the applications 131, 132, 141, 142, 143, then standardized so as to be able to be shared by all the participating applications. An ontology 160 differs notably from a conventional databank in that it allows for reasoning concerning concepts. An ontology, associated for example with an inference engine, allows for the automated creation of new relationships between the concepts by deduction based on the definitions of the initial relationships between concepts.

The ontology 160 and the directory of services 170 are, preferably, centralized and accessible to the sending and receiving terminals 101, 102, 111, 112, 113 through the network 150. In another embodiment of the system according to the invention, the ontology 160 and the directory of services 170 may be duplicated on each terminal if said terminal has sufficient resources in terms of memory available to store the two bases 160, 170. This embodiment has the advantage of avoiding the exchanges of data through the network 150 between the applications, the ontological base 160 and the directory of services 170. This then implies putting in place a system for synchronizing the knowledge bases 160 with one another and the directories of services 170 with one another.

FIG. 2 illustrates the steps implemented by the invention to adapt the syntax of the messages transmitted from a calling application 131 to a called application 141.

The application 131 executed on the terminal 101 seeks to transmit a data message 202a to a remote application 141 with which it communicates via the network 150. The transmission of a message 202a is done, for example, in the call by the application 131 to a function executed by the remote called application 141. The calling application 131 transmits the message 202a with a specific syntax S_{A} to the translation module 120 or in a directly non-hierarchical format. This syntax S_{A} is, for example, defined using the extensible markup language XML. It also transmit a means 203 of identifying the called application 141. This means 203 is, for example, the address of the receiving terminal 111 on the network 150 associated with an identifier of the service supplied by the called application 141.

In a variant embodiment for which the translation module 120 is centralized in a software bus to which all the participating applications are connected, the calling application 131 transmits to the software bus an identifier of the service with which it wants to dialogue and the software bus is responsible for determining the address of the receiving terminal 111 which hosts this service.

Firstly, the translation module 120 transforms the message 202a in order to give it a simple structure with a single level of depth, that is to say that all the elements that make up this message are placed end to end in no specific order in order to obtain a non-hierarchical data structure. This transformation is optional in as much as the calling application 131 may directly transmit the message 202a with a non-hierarchical format.

Secondly, the translation module 120 sends a request 210a to interrogate the directory of services 170 by sending it the identifier 203 in order to know the syntax S_{B} that the called application 141 uses. The directory of services 170 then transmits 201b to it the syntax S_{B} required in order to generate the skeleton of the format of the message 202b adapted to be interpreted by the called application 141. This syntax S_{B} uses, for example, different levels of depth and various data types to structure the elements of a message. All the elements defined by the syntaxes used by the participating applications 101, 111 are specified semantically and all the semantic concepts originate from the ontology 160 which is shared by all the applications 101, 111.

In a variant embodiment, the calling application 131 directly communicates with the directory of services 170 in order to recover the syntax S_{B} of the called application 141 and then communicates this syntax to the translation module 120.

Thirdly, the translation module 120 sends a request 220a to the ontological knowledge base 160 in order for the latter to transmit 220b to it the semantic concepts associated with the elements that form the content of the data message 202a. From these semantic concepts, the translation module 120 establishes a mapping between the semantic specifications of the data of the initial message 202a and those associated with the syntax S_{B}. The translation module then generates the elements of the message 202b which have the same semantic interpretation but which are structured according to the syntax S_{B} which enables the called application 141 to process this message. Once generated, the message 202b is transmitted to a transmission infrastructure 201 which transmits the message to the remote application 141 via a reception infrastructure 211.

In a variant embodiment of the invention, in the case where it is not possible to find a direct mapping between the semantic concepts of the calling application and those of the called application, the translation module 120 uses the relationships between semantic concepts present in the knowledge base 160 to widen the mapping searches.

FIG. 3 diagrammatically represents the use of an ontology comprising a number of concepts linked by relationships in the adaptation according to the invention of data structured according to a first format to a second format.

The ontology concerned contains a number of concepts used to semantically specify a client on the basis of a number of attributes. The ontology notably comprises the concepts of person 301 and of client 302 linked together by the relationship “is a” 311. The person 301 or client 302 concepts are linked by composition or aggregation relationships to the concepts of surname 303, first name 304, age 305 and sport 306.

The input message 321 of the adaptation method according to the invention is, for example, written in XML language and contains a certain number of data making it possible to identify a particular client. The semantic content of this message 321 corresponds to the person Martin Dupont, aged 18 and whose sport is swimming. This message 321 has a non-hierarchical data format, that is to say that the surname, first name, age and sport subjects are listed in succession without any particular structure, and they are also specified in French.

The format of the output message 323 of the method is different on the one hand because the fields specified in this message are rewritten in English and a structural separation is made between the “first name” and “surname” fields which define a first level of semantic specification of the content of this message and of other fields such as age of the client which are stored in a structure labeled “other_info”. Finally, the overall structure of the message relates to the concept of client 303 whereas that of the input message 321 relates to the concept of person 301.

The method according to the invention applies a transformation 322 of the input message 321 to the output message 323 whose semantic contents are identical by using the relationships between concepts of the ontology. The data are rearranged in the correct order and by observing the target structure. The method uses the semantic relationship “is a” 311 between the person 301 and client 303 concepts in order to perform a mapping between the data fields with the same semantic content in the two messages 321, 323. Finally, the unused data, for example those corresponding to the sport 306, are not included in the output message 323.

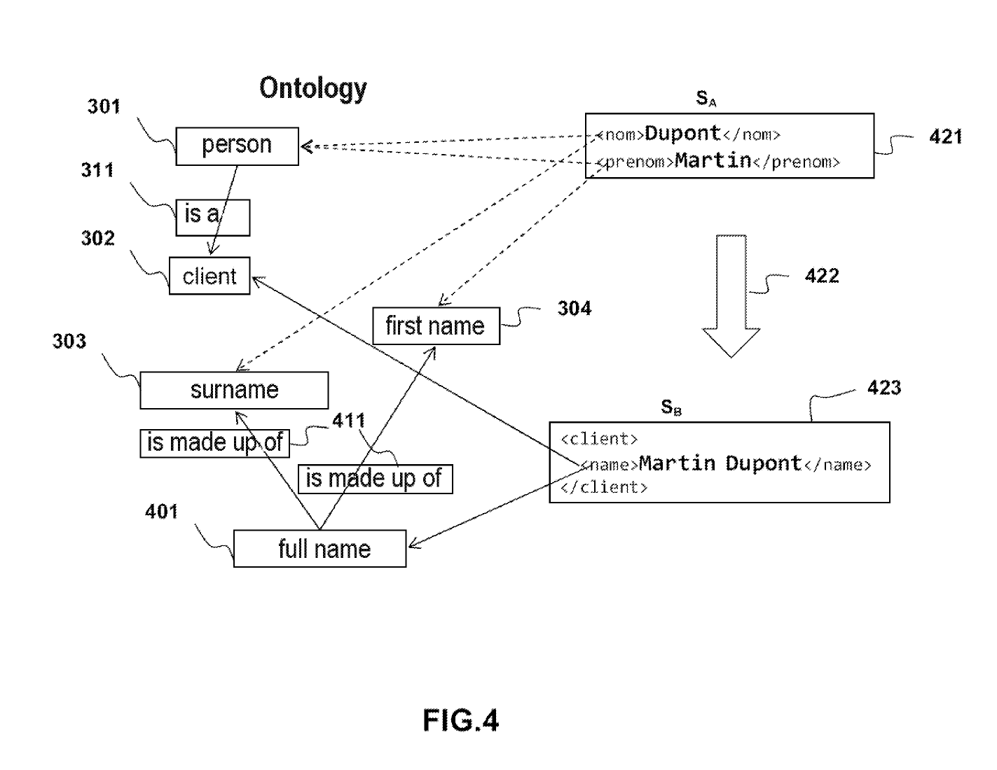

FIG. 4 diagrammatically represents a second example illustrating the method according to the invention. The same ontology is considered but with the addition of the concept of full name 401 which is linked to the concepts of surname 308 and first name 304 via the semantic relationship “is made up of” 411.

The input message 421 comprises the surname 303 of the person, in the example Dupont, and his first name 304 Martin. The structure of the output message 423 has a single data field associated with the full name concept 401 which combines the surname and first name as a single datum.

In this case, the transformation 422 applied uses both the “is a” relationship 311 and the “is made up of” relationship 411 in order to generate the datum comprising Martin Dupont in the output message 423.

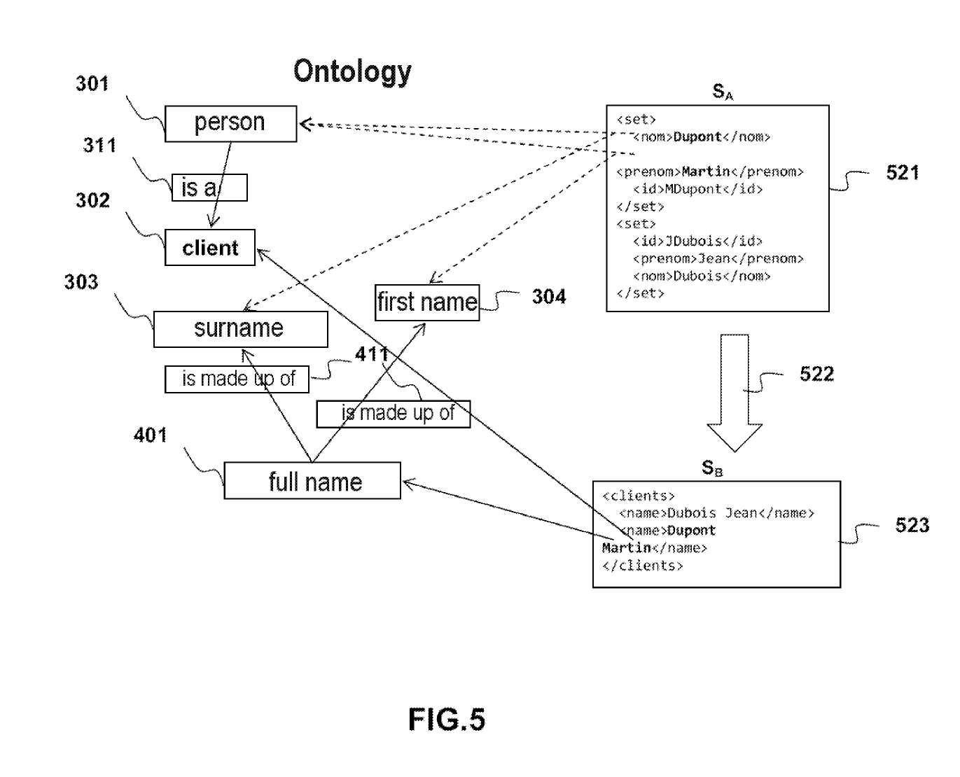

FIG. 5 diagrammatically represents a third example illustrating the method according to the invention. The input message 521 contains the semantic definition of a number of people 301, namely Martin Dupont and Jean Dubois. The method according to the invention makes it possible to define a set of non-ordered elements which will not be dissociated in the data adaptation. This notion is notably necessary for the management of types such as a list, a table, a collection. This notion makes it possible, while using the semantic relationships 311, 411 between concepts of the ontology, not to dissociate two initially associated data such as the surname and first name of a person. Thus, the method according to the invention generates 522 an output message 523 containing the names made up of Jean Dubois and Martin Dupont and not Jean Dupont and Martin Dubois as would be possible if no notion of ordered set were specified.

1. A system for adapting data comprising:
at least one sender executing at least one calling application, said calling application being adapted to generate first messages structured according to a first syntax S_{A} and addressed to a called application;
at least one receiver executing at least the called application, said called application being adapted to receive second messages structured according to a second syntax S_{B};
an ontological knowledge base common to the senders and receivers;
a directory of services common to the senders and receivers; and
a translation module connected to said knowledge base and to said directory configured to perform a direct translation of said first messages according to the second syntax S_{B},
wherein the sender and receiver are interconnected via a communication network.

2. The data adaptation system according to claim 1, wherein
said ontological knowledge base defines a set of semantic specifications of data exchanged between the sender and the receiver of said system, said specifications being formalized by semantic concepts interlinked by dependency relationships,
said translation module is adapted to use the content of said knowledge base to map semantic specifications of a first message structured according to the syntax S_{A} with those of a second message structured according to the syntax S_{B} so that said first and second messages present the same semantic content.

3. The data adaptation system according to claim 2, wherein the translation module is adapted to use the relationships between semantic concepts defined in the ontological knowledge base to widen mapping searches between the semantic specifications of the first and second messages structured according to two different syntaxes S_{A}, S_{B}.

4. The data adaptation system according to claim 1, wherein the directory of services contains all said syntaxes S_{A}, S_{B} associated with the applications executed by the senders and receivers of said system.

5. The data adaptation system according to claim 1, wherein the syntax S_{A} of the calling application is defined as a sequencing of a set of data with no particular structure or specific order.

6. The data adaptation system according to claims 2, wherein said semantic specifications contained in the ontological knowledge base (160) are defined using a resource description framework definition language or a web ontology language definition language.

7. The data adaptation system according to claim 4, wherein said syntaxes S_{A}, S_{B} contained in the directory of services are defined using an interface description language (IDL) or an XML schema description (XSD) language, or even by a diagram defined in a unified modeling language (UML).

8. The data adaptation system according to claim 1, wherein said translation module is specific to each sender or is common to all the applications executed by said senders and receivers of said system and centralized in a software bus.

9. A method for adapting data in a system comprising at least one sender executing at least one calling application and one receiver executing at least one called application, the senders and receivers being interconnected via a communication network (150), said calling application generating at least one first message addressed to said called application, said first message being structured according to a first syntax S_{A}, said called application being adapted to receive at least one second message structured according to a second syntax S_{B}, said method comprising:
associating said first message with an identifier of the called application that is the recipient of said first message;
determining the syntax S_{B} associated with the called application from the identifier;
direct translation of said first message into a format adapted to the syntax S_{B} but having the same semantic content as the first message, from a mapping between the semantic specifications of the syntax S_{A} and those of the syntax S_{B}; and
transmitting said second message to the called application via said communication network.
